(19) United States
(12) Patent Application Publication
(10) Pub. No.: US 2007/0115489 A1
(43) Pub. Date: May 24, 2007

(54) Printing apparatus and control method therefor, and printing system

(75) Inventors: Kouji Yorimoto, Saitama (JP); Hideaki Sugimoto, Saitama (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/442,169

(22) Filed: May 30, 2006

(30) Foreign Application Priority Data
Nov. 24, 2005 (JP) 2005-338793

(51) Int. Cl. G06F 3/12

(52) U.S. Cl. 358/1.13; 358/426.06

(57) ABSTRACT

A printing apparatus including an engine section that forms an image on a sheet of paper utilizing laser light on the basis of image data described in a page description language in printing data, which includes a decomposition processing section that acquires the image data from the printing data, a printing buffer section that accumulates the image data acquired by the decomposition processing section, and an engine controller that, in a case where it is identified that a sender terminal of the printing data is an image reading apparatus, causes the engine section to start to print the image data at a time when a prescribed number of a band of the image data is accumulated in the printing buffer section.

### BACKGROUND OF THE INVENTION

1. Field of the Invention

The present invention pertains to a printing apparatus and a control method therefor, and a printing system, and particularly relates to a printing apparatus and a control method therefor, and a printing system which are adapted to start printing operation without spooling for the printing from an image reading apparatus.

2. Description of the Related Art

In recent years, for pieces of OA (Office Automation) equipment, such as copying machines and multifunction machines, price reduction has been promoted, and the hardware manufacturers which offer these pieces of OA equipment to the customers have been demanded to cope with such trend.

Therefore, the scanner printer system (the printing system) which operates a scanner and a printer in connection with each other for implementing printing processing, such as copying processing, has been proposed.

Such a printing system offers advantages that printing processing, such as copying processing, can be implemented with a simple and convenient configuration, and further the introduction cost for the system can be substantially suppressed, compared to that for copying machines and multifunction machines.

The flow of the printing processing in this type of printing system will be described with reference to FIG. 11. Herein, an application where the printer is a laser printer will be described.

First, in the scanner, a document as a scanning object is set, and the start pushbutton is depressed to start the scanning processing of the document. With this scanning processing being started, the image data is read line by line from the document to be sequentially accumulated in the buffer. And, when the scanning processing is terminated with one sheet of image data having been accumulated, sending it to the printer is started.

In the printer, the printer controller receives the image data sent from the scanner to accumulate that data in the buffer, sending an activation request to the engine section.

The engine section, which has received the activation request, starts the printing setup, using that request as a trigger. For example, it starts energizing the heater to raise the temperature of the fixing section to above a certain value to get into the printable state.

When the printer controller has accumulated one sheet of image data in the buffer, it sends a printing start signal to the engine section, starting the transfer of the image data. The engine section, which has received this image data, forms an image on a paper on the basis of the image data, starting the printing processing. Then, when the printing is completed, this processing is terminated.

By the way, as the related art for shortening the period of time for printing processing on the printer side, that as given in Japanese Patent Appllication Laid-Open No. 2001-260429 is known. This patent literature refers to an art which, if a printer having both direct and spooling modes is used, and the printing is performed in the direct mode, allows printing processing to be performed without spooling, starting the transfer of the printing data to the engine section as soon as one sheet of image data is accumulated.

As described above, with the related art printing system, when the entire one sheet of image data which is sent from the scanner has been accumulated, the printer starts the transfer of the image data to the engine section, starting the printing processing. This is because, with a laser printer, once the printing operation is started, it cannot be stopped on the way.

Generally, printing data from a personal computer, such as a host terminal, contains one sheet of image data, and on the printer side, the image data is once developed into bit map images for giving a printing output.

On the other hand, the printing data from a scanner contains image data composed of bit map images by a band unit, and on the printer side, the bit map images in the printing data are extracted as they are, for giving a printing output.

In other words, the printing data (by a band unit) sent from the scanner and the printing data (by a page unit) sent from the host terminal, or the like, are quite different from each other in structure and the rule for data transmission.

Therefore, even if, in printing from the host terminal, the printing cannot be started until one sheet of image data is completely accumulated, it would be reasonable that, in printing from the scanner, the printing is started before one sheet of image data being completely accumulated. Starting the printing from the scanner with the same timing as that for the printing from the host terminal produces a wasteful delay of the printing operation, which results in a reduction in throughput.

### SUMMARY OF THE INVENTION

Then, the present invention has been made in view of this situation and provides a printing apparatus and a control method therefor, and a printing system which are adapted to start the printing operation without spooling in printing from the image reading apparatus.

An aspect of the invention provides a printing apparatus including an engine section that forms an image on a sheet of paper utilizing laser light on the basis of image data described in a page description language in printing data, which includes: a decomposition processing section that acquires the image data from the printing data, a printing buffer section that accumulates the image data acquired by the decomposition processing section, and an engine controller that, in a case where it is identified that a sender terminal of the printing data is an image reading apparatus, causes the engine section to start to print the image data at a time when a prescribed number of a band of the image data is accumulated in the printing buffer section.

### BRIEF DESCRIPTION OF THE DRAWINGS

An embodiment of the present invention will be described in detail based on the following figures, in which:

FIG. 1 is a block diagram illustrating one example of the overall configuration of the printing system pertaining to the present invention;

FIG. 2 is a block diagram illustrating one example of the internal configuration of the scanner 10 as shown in FIG. 1;

FIG. 3 is a block diagram illustrating a part of the functional configuration of the scanner controller 14 as shown in FIG. 2;

FIG. 4 is a diagram illustrating one example of the structure of printing data;

FIG. 5 is a block diagram illustrating one example of the internal configuration of the printer 20 as shown in FIG. 1;

FIG. 6 is a block diagram illustrating a part of the functional configuration of the printer controller 24 as shown in FIG. 5;

FIG. 7 is a sequence chart diagram illustrating one example of the flow of processing in the printing system as shown in FIG. 1;

FIG. 8 is a flowchart illustrating one example of the operation of the scanner 10 as shown in FIG. 1;

FIG. 9 is a flowchart illustrating one example of the operation of the printer 20 as shown in FIG. 1;

FIG. 10 is a block diagram illustrating the functional configuration of the scanner controller 14 giving a modification pertaining to the present invention; and

FIG. 11 is a sequence chart diagram illustrating one example of the flow of processing in the related art scanner and printer.

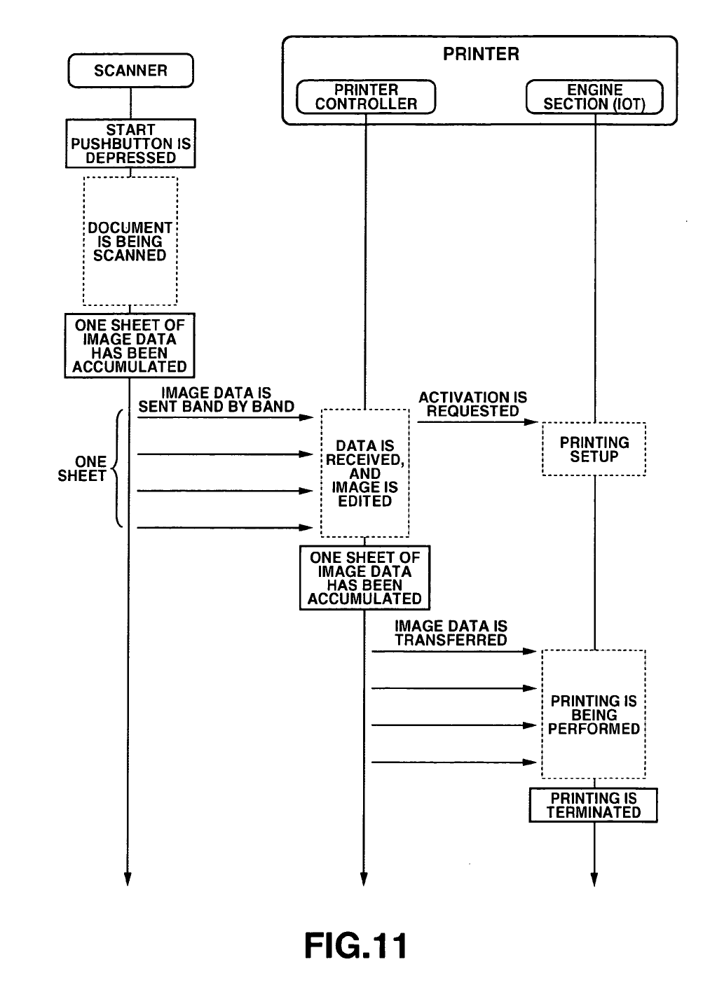

### DETAILED DESCRIPTION OF THE INVENTION

Hereinbelow, an embodiment of the printing apparatus and the control method therefor, and the printing system pertaining to the present invention will be described in detail with reference to the attached drawings.

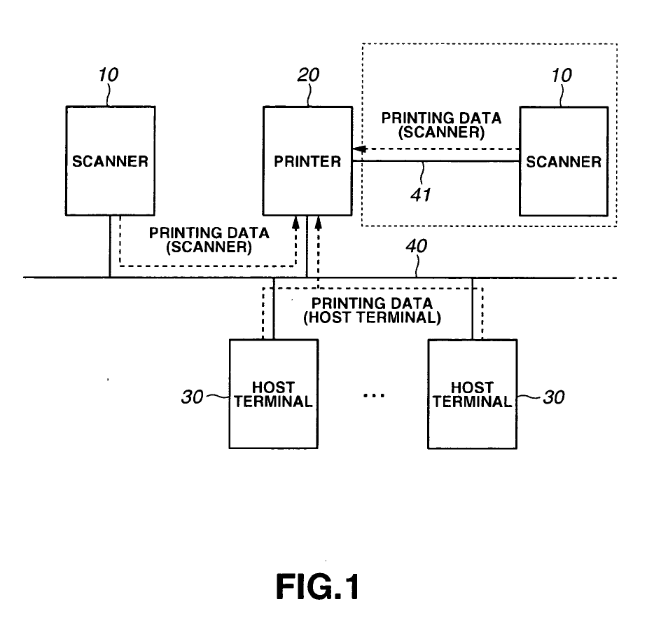

FIG. 1 is a block diagram illustrating one example of the overall configuration of the printing system pertaining to the present invention.

In this printing system, a scanner 10, a printer 20, and one or plural host terminals 30 are connected to one another through a network, such as a LAN (Local Area Network) 40.

In the present embodiment, an application where the scanner 10 and the printer 20 are connected to each other through the LAN 40 will be described, however, only the mutual communication between the scanner 10 and the printer 20 is needed, and for example, the scanner 10 and the printer 20 may be directly connected to each other with the use of a USB (Universal Serial Bus), a Centronix interface, or the like, 41, as shown in the dotted line frame in the same figure.

The scanner 10 is an image reading apparatus which reads a figure, a photo, or characters from a document placed on a platen glass, or fed thereon, by scanning operation, and converts it into digital data (image data).

The scanner 10 reads the image data line by line from the document (the data obtained is hereafter to be called line data), and accumulates it in a buffer (a scanner buffer 13 later described). And, when one band (a prescribed number of a line) of image data is accumulated in the buffer, the scanner 10 uses the data to generate printing data described in a prescribed page description language, sending it to the printer 20.

Thereafter, every time one band of image data is accumulated in the buffer, the scanner 10 generates printing data for sending it to the printer 20.

The printer 20 is a laser printer (a laser type printing apparatus) which utilizes laser light. When printing data is sent from the scanner 10 or the host terminal 30, the printer 20 interprets the page description language in the printing data for implementing the printing processing. By operating the printer 20 in connection with the scanner 10 for outputting the image data read by the scanner 10 with the printer 20, the copying function can be realized.

When the printer 20 has received the printing data from the scanner 10, it extracts (in some cases develops) the image data contained as a band in the received data, and accumulates it in a buffer (a printer buffer 22 later described). And, with one band of image data being accumulated in the buffer, the printer 20 starts to transfer the image data to an engine section (an engine section 21 later described), starting the printing processing. Therefore, when the printing data sent from the scanner 10 is printed in the printer 20, the buffer in the printer 20 (the printer buffer 22 later described) functions as a band buffer, which means that the printing operation is started without spooling.

The host terminal 30 is a personal computer, or the like, which is handled by the user, and to the LAN 40, one or plural host terminals 30 are connected. The user can select a desired file (printing object data) from this host terminal 30 for requesting printing it of the printer 20.

In the present embodiment, an application where, with one band of image data being accumulated in the buffer in the printer 20, transferring the image data to the engine section is started, the printing processing being started, is described, however, this provides only one example, and at the time when two bands or a few bands of image data is accumulated, the printing may be started, and thus the timing for starting the printing may be altered to suit to the performance of the engine section of the printer to which the present invention is applied, the communication environment between the scanner and the printer, and the like.

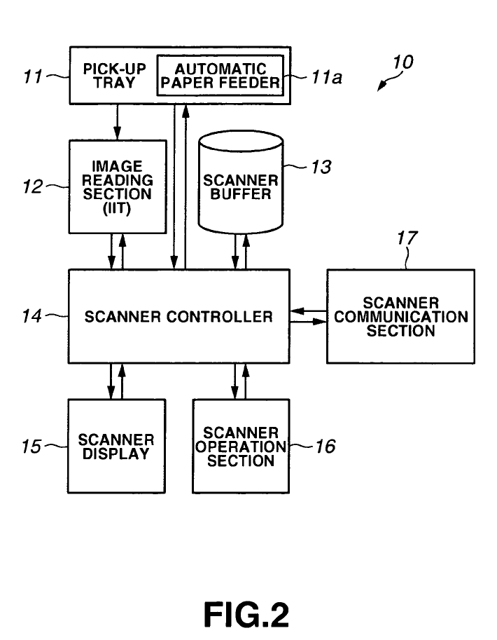

FIG. 2 is a block diagram illustrating one example of the internal configuration of the scanner 10 as shown in FIG. 1.

The scanner 10 is configured to comprise a pick-up tray 11 on which documents as scanning objects are loaded; an image reading section (IIT, i.e., Image Input Terminal) 12 which is composed of an illumination lamp, a lens, a CCD (Charge Coupled Device), and the like, and performs scanning processing of a document loaded on the pick-up tray 11 to read the image data line by line; a scanner buffer 13 which is composed of an RAM (Random Access Memory), and the like, and temporarily accumulates the read image data; a scanner controller 14 which is composed of a CPU (Central Processing Unit), various ASICs (Application Specific Integrated Circuits), and the like, and comprehensively controls the scanner 10; a scanner display 15 which is a display device, such as a liquid crystal display; a scanner operation section 16 which is an input device, such as an operation pushbutton; and a scanner communication section 17 which is composed of a network card, a USB port, and the like, being a communication interface apparatus connecting the scanner 10 with the other apparatuses (the printer 20, the host terminal 30, and the like).

In the pick-up tray 11, an automatic paper feeder 11a is provided, and even when plural documents are loaded, this automatic paper feeder 11a feeds out the documents one by one in sequence to carry them to a delivery tray (not shown) through the path on a platen glass (not shown).

The image reading section 12 performs scanning processing of the document fed on the platen glass by the automatic paper feeder 11a for reading the image data. By repeating this, the documents loaded on the pick-up tray 11 can be continuously read.

In the scanner buffer 13, the image data read in the image reading section 12 is sequentially accumulated line by line. As described above, with one band of image data being accumulated, the data is sent to the printer 20, thus the accumulation capacity which is required of the scanner buffer 13 is only one band of image data.

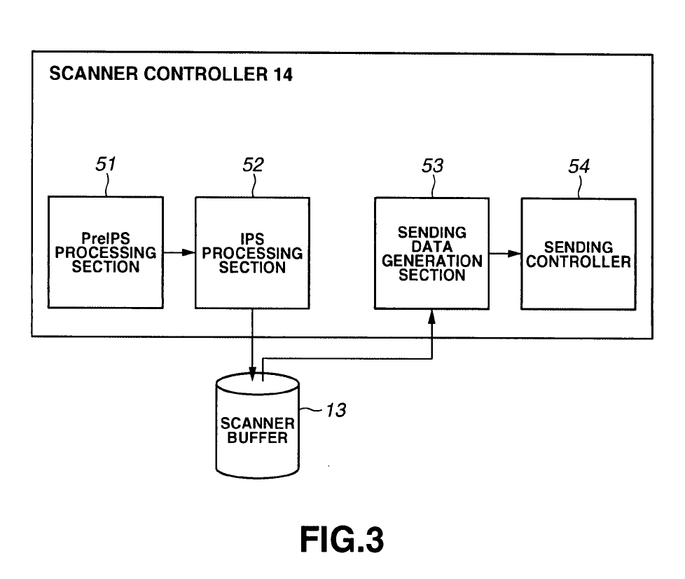

Herein, using FIG. 3, a part of the functional configuration of the scanner controller 14 will be described.

The scanner controller 14 is configured to comprise a PreIPS processing section 51, an IPS processing section 52, a sending data generation section 53, and a sending controller 54 as various processing function sections.

The PreIPS processing section 51 provides functions of making shading compensation, color completion, and the like, for the line data inputted from the image reading section 12, and the IPS processing section 52 performs image editing processing of the image data subjected to a prescribed processing in the PreIPS processing section 51 in accordance with the printing parameters set by the user, and stores the data after the editing in the scanner buffer 13.

The line data subjected to a prescribed processing in the IPS processing section 52 and outputted is composed of bit map images edited in accordance with the printing parameters, thus the printer 20 which has received this data can perform the printing processing using the images as they are.

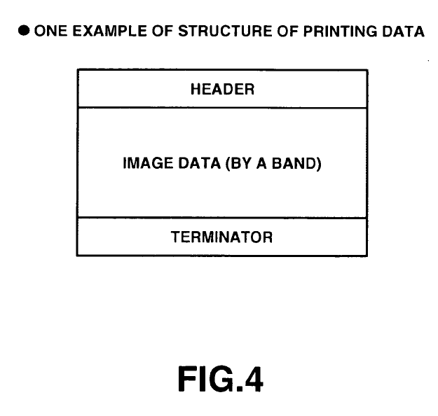

With one band of image data being accumulated in the scanner buffer 13, the sending data generation section 53 acquires the data, and generates printing data described in a prescribed page description language. The printing data generated in this sending data generation section 53 provides a structure in which data (the header and the terminator) described in a page description language is added to the image data at the beginning and the last thereof as shown in FIG. 4, for example.

The sending controller 54 sends the printing data generated in the sending data generation section 53 to the printer 20 through the scanner communication section 17. This is a description of the respective functional blocks forming a part of the functional configuration of the scanner controller 14.

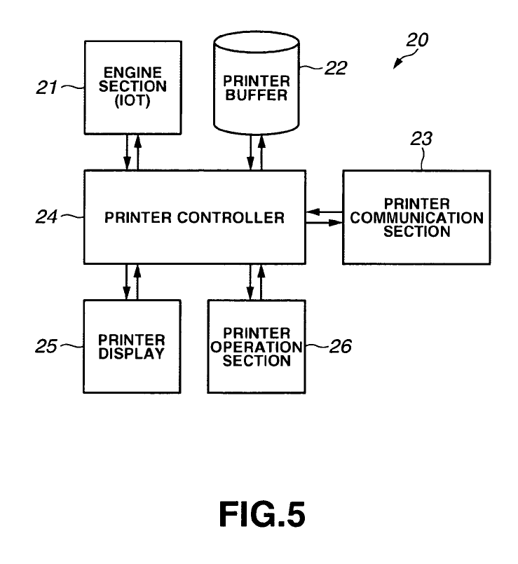

FIG. 5 is a block diagram illustrating one example of the internal configuration of the printer 20 as shown in FIG. 1.

The printer 20 is configured to comprise an engine section (an IOT, i.e., Image Output Terminal) 21 which is composed of a photosensitive drum, a transfer belt, and the like, and performs printing processing by forming an image on the paper on the basis of the printing data received; a printer buffer 22 which is composed of an RAM (Random Access Memory), and the like, and temporarily accumulates the image data received; a printer communication section 23 which is composed of a network card, a USB port, and the like, being a communication interface apparatus connecting the printer 20 with the other apparatuses (the scanner 10, the host terminal 30, and the like); a printer controller 24 which is composed of a CPU (Central Processing Unit), various ASICs (Application Specific Integrated Circuits), and the like, and comprehensively controls the printer 20; a printer display 25 which is a display device, such as a liquid crystal display; and a printer operation section 26 which is an input device, such as an operation pushbutton.

The engine section 21 is configured to operate using laser light, and thus once the printing operation is started, it will not be stopped on the way. Therefore, if the speed at which the image data is supplied to this engine section 21 is lower than the printing speed for the engine section 21, an overrun error (a white strip) is caused.

In the printer buffer 22, the image data sent from the scanner 10 is accumulated. As described above, with one band of image data being accumulated, the data is transferred to the engine section 21, the printing processing being started, thus, when the printing data sent from the scanner 10 is printed, the printer buffer 22 functions as a band buffer, which means that the printing operation is started without spooling.

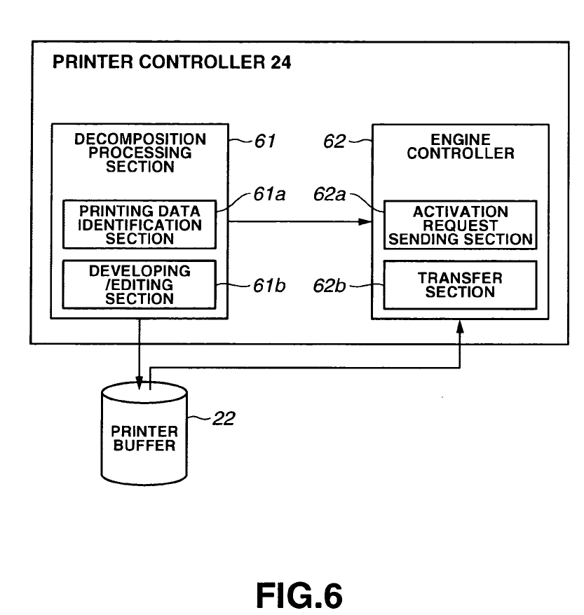

Herein, using FIG. 6, a part of the functional configuration of the printer controller 24 will be described.

The printer controller 24 is configured to comprise a decomposition processing section 61 and an engine controller 62 as various processing function sections.

The decomposition processing section 61 provides a function of interpreting the page description language in the printing data received through the printer communication section 23 to develop the data into bit map images, being configured to comprise a printing data identification section 61a and a developing/editing section 61b.

The printing data identification section 61a analyzes the printing data received, and identifies whether it is printing data sent from the scanner 10 or that sent from the host terminal 30. This identification is carried out by referring to the header in the printing data that is written in a page description language to specify the sender terminal.

The developing/editing section 61b interprets the page description language in the printing data to develop the data into bit map images, carrying out image editing processing of the images, such as enlargement, reduction, or turning. In the printing data sent from the scanner 10, image data composed of bit map images is contained, thus, the bit map images are basically extracted directly from the image data. However, in some cases, the bit map images are subjected to image editing processing, such as reconversion.

The engine controller 62 provides functions of transferring image data to the engine section 21, and sending a control signal for controlling the printing processing performed in the engine section 21, being configured to comprise an activation request sending section 62a and a transfer section 62b.

The activation request sending section 62a provides a function of sending an activation request to the engine section 21 for causing it to start the printing setup. The engine section 21, which has received this activation request, starts energizing the heater to raise the temperature of the fixing section to above a certain value, for example, to get into the printable state.

The transfer section 62b provides a function of transferring image data to the engine section 21. More specifically, with one band of image data being accumulated in the printer buffer 22, the transfer section 62b sends a printing start signal to the engine section 21, starting the transfer of image data.

This transfer section 62b acquires the identification result for the printing data from the decomposition processing section 61, and on the basis of the identification result, determines the timing of starting the transfer of image data to the engine section 21. More specifically, if the printing data is that from the scanner 10, the transfer of the image data to the engine section 21 is started with one band of image data being accumulated in the printer buffer 22, while, if the printing data is that from the host terminal 30, the transfer of the image data is started with a timing at which one sheet of image data is accumulated in the printer buffer 22, as conventional.

As described above, with the engine section 21, once the printing operation is started, it will not be stopped on the way. Therefore, if the speed at which the data is transferred from the printer controller 24 is lower than the printing speed for the engine section 21, an overrun error (a white strip) is caused.

Therefore, it is necessary that the transfer start timing for the image data from the transfer section 62b be previously set in consideration of at least the reaching speed for the printing data, and the printing speed for the engine section 21. For example, if one sheet is divided into four bands, and it is required that one band of printing data be received every 2.5 sec from the scanner 10, and one band of data be transferred to the engine section 21 every 1.5 sec, the transfer start for the image data must occur at a timing after 2 or more bands of image data having been received. This is a description of the respective functional blocks forming a part of the functional configuration of the printer controller 24.

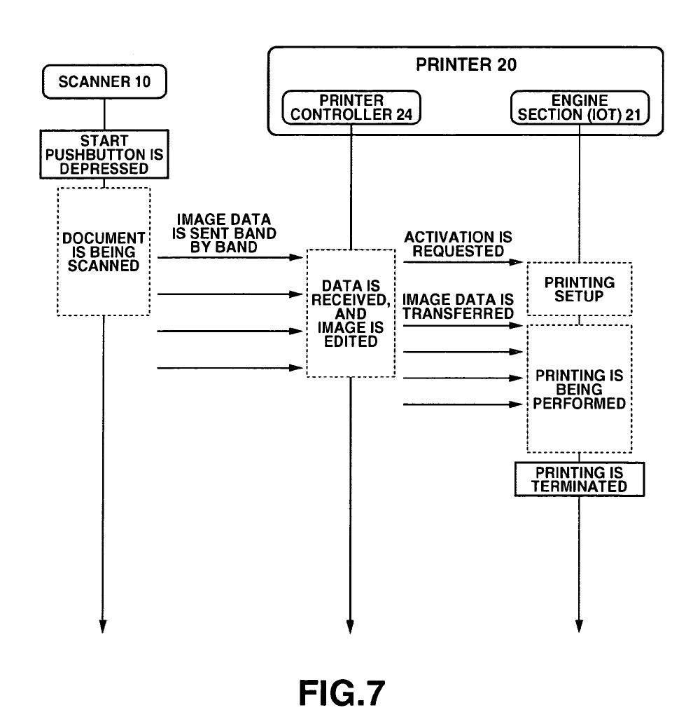

FIG. 7 is a sequence chart diagram illustrating one example of processing in the printing system as shown in FIG. 1.

First, when, in the scanner 10, a document as a scanning object is set, the start pushbutton is depressed, the scanning processing of the document is started. With the scanning processing being started, the line data is read from the document, being sequentially accumulated in the scanner buffer 13. With one band of image data being accumulated in the scanner buffer 13, the scanner 10 starts sending the printing data to the printer 20. Such sending processing is performed every time one band of image data is accumulated in the scanner buffer 13, and in the printing data sent, one band of image data is contained.

In the printer 20, when the printing data is received through the printer communication section 23, the printer controller 24 extracts the image data (the bit map images) from the received data to accumulate it in the printer buffer 22, sending an activation request to the engine section 21.

The engine section 21, which has received this activation request, starts the printing setup, using the request as a trigger. For example, it starts energizing the heater to raise the temperature of the fixing section to above a certain value to get into the printable state.

With one band of image data being accumulated in the printer buffer 22, the printer controller 24 sends a printing start signal to the engine section 21, starting the transfer of the image data. The engine section 21 starts the printing processing by forming an image on the paper on the basis of the image data. Then, when the printing is completed, this processing is terminated.

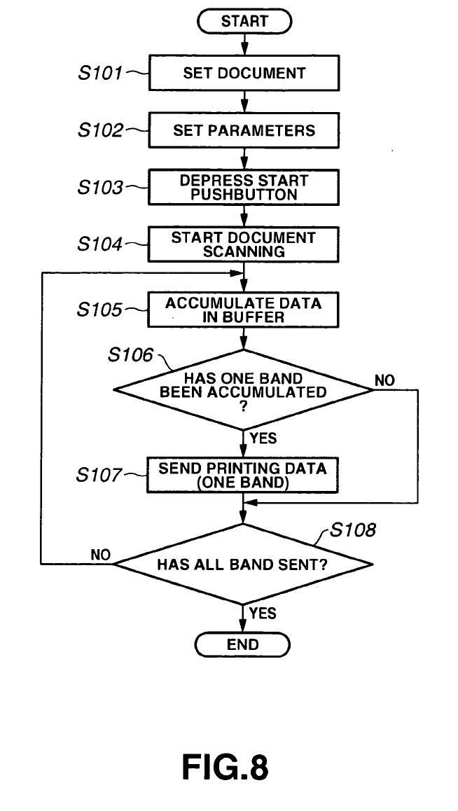

FIG. 8 is a flowchart illustrating one example of the operation of the scanner 10 as shown in FIG. 1.

When a document as the scanning object is set on the platen glass, or in the automatic paper feeder 11a, by the user (step S101); setting the printing parameters and the like are performed (step S102); and the start pushbutton is depressed (step S103), the scanning processing of the document is started (step S104).

With the scanning processing being started, the line data read from the document in the image reading section 12 is sequentially inputted to the PreIPS processing section 51, and after, in the PreIPS processing section 51, a prescribed correction processing, or the like, being provided, the line data is further inputted to the IPS processing section 52.

The line data which has passed through the IPS processing section 52, and the like, to be subjected to a prescribed image editing processing, or the like, is accumulated in the scanner buffer 13 (step S105). Then, with one band of image data being accumulated in the scanner buffer 13 (YES at step S106); the sending data generation section 53 acquires the one band of image data accumulated in the scanner buffer 13 to generate printing data described in a prescribed page description language; and the generated printing data is sent to the printer 20 by the sending controller 54 through the scanner communication section 23 (step S107).

The processing operations from the above-mentioned step S105 to the step S107 are repetitively performed if sending of all the bands is not completed (NO at step S108), and when sending all the bands has been completed (YES at step S108), this processing is terminated.

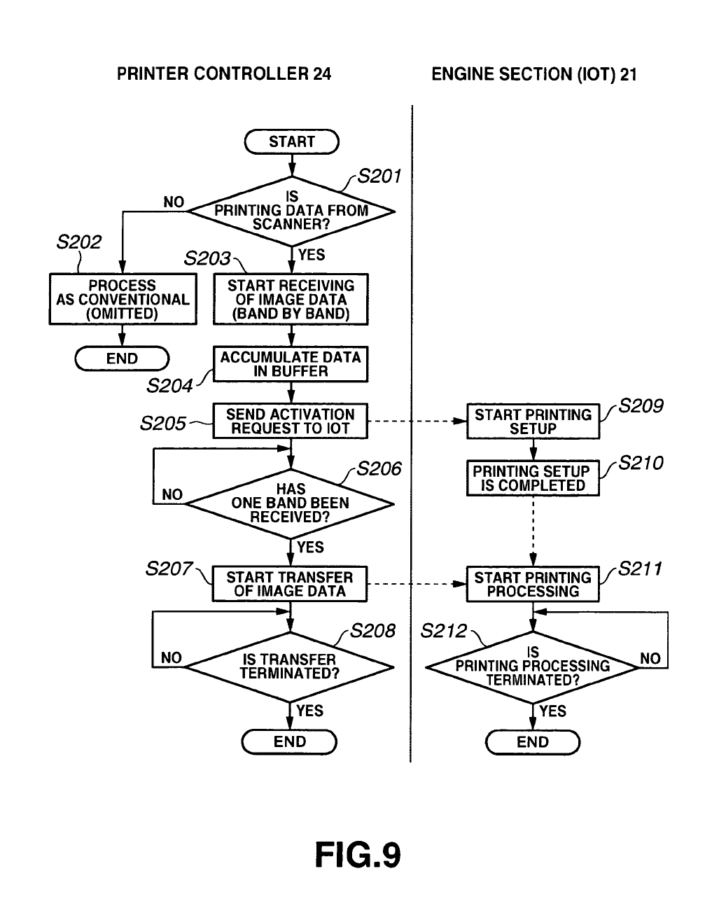

FIG. 9 is a flowchart illustrating one example of the operation of the printer 20 as shown in FIG. 1.

When the printer 20 has received the printing data through the printer communication section 23, the printing data identification section 61a analyzes the received data, and identifies whether it is printing data sent from the scanner 10 or that sent from the host terminal 30 (step S201). As described above, this identification is carried out by referring to the header in the printing data that is written in a page description language, to specify the sender terminal.

As a result of this identification, when it is found that the printing data is that from the host terminal 30 (NO at step S201), the processing as conventional, which description is omitted because it is well-known processing, is performed (step S202), this processing being terminated; on the other hand, when the printing data is that from the scanner 10 (YES at step S201), the printing data in which the image data is contained as a band is sequentially received (step S203); and the image data composed of bit map images is extracted from the received data to be accumulated in the printer buffer 22 (step S204). This processing is continued to be performed so long as the printing data is sent.

With the accumulation in the buffer being started, the printer controller 24 sends an activation request from the activation request sending section 62a (step S205) to activate the engine section 21. The engine section 21, which has received this activation request, uses the request as a trigger to start the printing setup (step S209), getting into the printable state (step S210).

With one band of image data being accumulated in the printer buffer 22 (YES at step S206), the printer controller 24 sends a printing start signal to the engine section 21 from the transfer section 62b, starting the transfer of the image data (step S207). With the transfer of the image data being started, the engine section 21 starts the printing processing by forming an image on the recording medium, such as a paper, on the basis of the image data (step S211).

And, with the transfer of the image data from the printer controller 24 being terminated (YES at step S208), the printing processing in the engine section 21 is also terminated (YES at step S212), this processing being terminated.

As described above, the system according to the present invention is configured such that the image data is extracted from the printing data to be accumulated in the printer buffer 22, and in the case where it is identified that the sender terminal for such printing data is the scanner 10, the engine section 21 is caused to start the printing for the image data at the time when one band of image data is accumulated in the printer buffer 22, thus for printing from the scanner 10, the printing operation is started without spooling, which allows shortening of the first printout time (FPOT) from the copying start instruction (from the start pushbutton being depressed) to the completion of output of the first sheet.

In the above-mentioned embodiment, an application where, with a prescribed number of bands of image data being accumulated in the printer buffer 22, the transfer of the image data to the engine section 21 is started, the printing processing being started, has been described, however, the system may be configured such that the start of printing processing is instructed from the scanner 10 side. In other words, the start timing for the printing processing may be determined on the scanner 10 side, and the printer 20 may be instructed by the scanner 10 to start the printing processing.

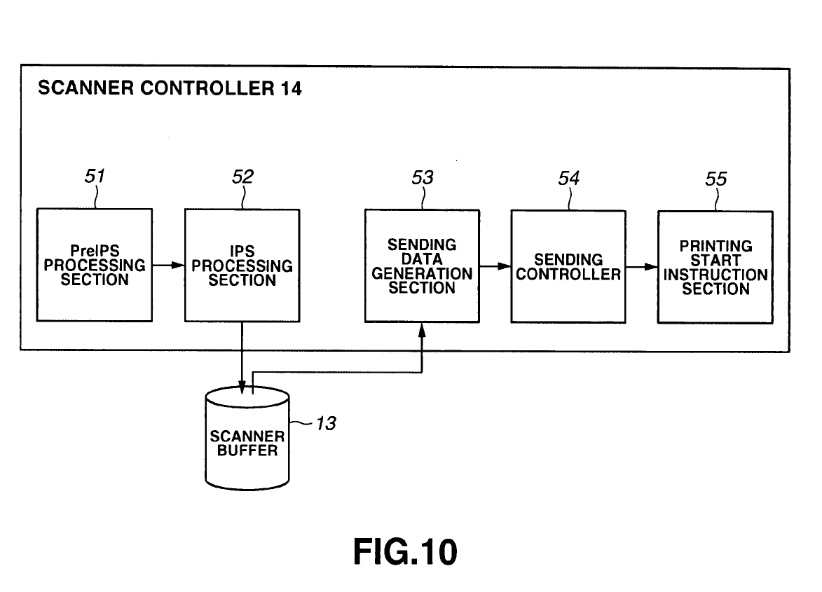

In this application, as shown in FIG. 10, the system is configured such that a printing start instruction section 55 is provided in the scanner controller 14 of the scanner 10, and by this printing start instruction section 55, a printing start command is sent to the printer 20, with the number of bands of image data that has been sent to the printer 20, the reaching speed for the printing data to the printer 20, the printing speed for the engine section 21 of the printer 20, and the like, being taken into account. On the printer 20 side, with this printing start command being received, the transfer of the image data to the engine section 21 is started by the engine controller 62 for starting the printing processing.

In the above-mentioned embodiment, an application where the present invention is embodied by combining a scanner 10 which sends printing data in parallel with the scanning processing, with a printer 20 to which the present invention is applied has been described, however, the present invention may be embodied by combining the above-mentioned printer 20 with a scanner 10 which, after accumulating one sheet of image data, starts sending the printing data to the printer 20. Also in this application, the purpose of the present invention of shortening the first printout time (FPOT) can be achieved, although the effect is slightly reduced.

Besides to these, the present invention may be embodied with any alteration being given within the scope of the spirit thereof, being not limited to the embodiment as described above with reference to the attached drawings.

As described above, a first aspect of the invention provides a printing apparatus including an engine section that forms an image on a sheet of paper utilizing laser light on the basis of image data described in a page description language in printing data, which includes: a decomposition processing section that acquires the image data from the printing data, a printing buffer section that accumulates the image data acquired by the decomposition processing section, and an engine controller that, in a case where it is identified that a sender terminal of the printing data is an image reading apparatus, causes the engine section to start to print the image data at a time when a prescribed number of a band of the image data is accumulated in the printing buffer section.

A second aspect of the invention provides the printing apparatus of the first aspect of the invention, in which the engine controller may cause the engine section to start to print the image data on the basis of an instruction from an external.

A third aspect of the invention provides the printing apparatus of the first or the second aspect of the invention, in which the engine controller may cause the engine section to start to print the image data at a timing for which at least a reaching speed of the printing data and a printing speed of the engine section are taken into account.

A fourth aspect of the invention provides a control method of a printing apparatus including an engine section that forms an image on a sheet of paper utilizing laser light on the basis of image data described in a page description language in printing data, which includes: acquiring, by a decomposition processing section, the image data from the printing data, accumulating the image data acquired by the decomposition processing section in a printing buffer section, and in a case where it is identified that a sender terminal of the printing data is an image reading apparatus, causing the engine section to start to print the image data from an engine controller at a time when a prescribed number of a band of the image data is accumulated in the printing buffer section.

A fifth aspect of the invention provides a printing system having an printing apparatus and an image reading apparatus that reads image data from a document and sends printing data, in which the read image data is described in a prescribed page description language, to the printing apparatus, and the printing apparatus including an engine section that forms an image on a sheet of paper utilizing laser light on the basis of the image data described in the page description language in the printing data, in which the image reading apparatus includes: an image reading section that reads the image data line by line from the document, a buffer section that sequentially accumulates the image data read line by line by the image reading section, and a sending controller that starts to send the image data to the printing apparatus at a time when a prescribed number of a line of the image data is accumulated in the buffer section, and the printing apparatus includes: a decomposition processing section that acquires the image data from the printing data sent from the sending controller, a printing buffer section that accumulates the image data acquired by the decomposition processing section, and an engine controller that causes the engine section to start to print the image data at a time when a prescribed number of a band of the image data is accumulated in the printing buffer.

A sixth aspect of the invention provides the printing system of the fifth aspect of the invention, in which the image reading apparatus may further include a printing start instruction section that instructs the engine controller to start to print, and the engine controller may cause the engine section to start to print the image data on the basis of a printing start instruction from the printing start instruction section.

An aspect of the present invention provides a configuration such that the image data is acquired from the printing data to be accumulated in the buffer, and in the case where it is identified that the sender terminal for the printing data is an image reading apparatus, the engine section is caused to start the printing for the image data at the time when a prescribed number of bands of image data is accumulated in the buffer, thus for printing from the image reading apparatus, the printing operation is started without spooling, which allows shortening the first printout time (FPOT) from the copying start instruction (from the start pushbutton being depressed) to the completion of output of the first sheet.

The printing apparatus and the control method therefor, and the printing system of the present invention are applicable to any printing systems in which an image reading apparatus and a printing apparatus are disposed, and especially, they allow printing (copying) processing using an image reading apparatus in connection with a printing apparatus to be implemented with a convenient and inexpensive configuration, thus they can be effectively utilized in any offices and places where copying work is frequently performed.

The foregoing description of the embodiment of the present invention has been provided for the purpose of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-338793 filed on Nov. 24, 2005 including specification, claims, drawings and abstract is incorporated herein by reference in its entirety.

1. A printing apparatus including an engine section that forms an image on a sheet of paper utilizing laser light on the basis of image data described in a page description language in printing data, comprising:
a decomposition processing section that acquires the image data from the printing data,
a printing buffer section that accumulates the image data acquired by the decomposition processing section, and
an engine controller that, in a case where it is identified that a sender terminal of the printing data is an image reading apparatus, causes the engine section to start to print the image data at a time when a prescribed number of a band of the image data is accumulated in the printing buffer section.

2. The printing apparatus of claim 1, wherein the engine controller causes the engine section to start to print the image data on the basis of an instruction from an external.

3. The printing apparatus of claim 1, wherein the engine controller causes the engine section to start to print the image data at a timing for which at least a reaching speed of the printing data and a printing speed of the engine section are taken into account.

4. A control method of a printing apparatus including an engine section that forms an image on a sheet of paper utilizing laser light on the basis of image data described in a page description language in printing data, comprising:
acquiring, by a decomposition processing section, the image data from the printing data,
accumulating the image data acquired by the decomposition processing section in a printing buffer section, and
in a case where it is identified that a sender terminal of the printing data is an image reading apparatus, causing the engine section to start to print the image data from an engine controller at a time when a prescribed number of a band of the image data is accumulated in the printing buffer section.

5. A printing system having an printing apparatus and an image reading apparatus that reads image data from a document and sends printing data, in which the read image data is described in a prescribed page description language, to the printing apparatus, and the printing apparatus including an engine section that forms an image on a sheet of paper utilizing laser light on the basis of the image data described in the page description language in the printing data, wherein
the image reading apparatus comprises:
an image reading section that reads the image data line by line from the document,
a buffer section that sequentially accumulates the image data read line by line by the image reading section, and
a sending controller that starts to send the image data to the printing apparatus at a time when a prescribed number of a line of the image data is accumulated in the buffer section, and
the printing apparatus comprises:
a decomposition processing section that acquires the image data from the printing data sent from the sending controller,
a printing buffer section that accumulates the image data acquired by the decomposition processing section, and
an engine controller that causes the engine section to start to print the image data at a time when a prescribed number of a band of the image data is accumulated in the printing buffer.

6. The printing system of claim 5, wherein the image reading apparatus further comprises a printing start instruction section that instructs the engine controller to start to print, and
the engine controller causes the engine section to start to print the image data on the basis of a printing start instruction from the printing start instruction section.

7. The printing apparatus of claim 2, wherein the engine controller causes the engine section to start to print the image data at a timing for which at least a reaching speed of the printing data and a printing speed of the engine section are taken into account.
